(19) United States
(12) Patent Application Publication
(10) Pub. No.: US 2004/0010090 A1
(43) Pub. Date: Jan. 15, 2004

(54) Thermoplastic elastomer composition

(76) Inventors: Keisuke Chino, Kanagawa Prefecture (JP); Manabu Kato, Kanagawa Prefecture (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/608,068

(22) Filed: Jun. 30, 2003

(30) Foreign Application Priority Data
Jul. 5, 2002 (JP) 2002-197414

(51) Int. Cl. C08F 275/00

(52) U.S. Cl. 525/242; 525/274

(57) ABSTRACT

A thermoplastic elastomer composition has a thermoplastic elastomer that contains a carbonyl-containing group and a nitrogen-containing heterocycle on a side chain thereof and a compound that contains a metal element belonging to Group 1 of the periodic table. The thermoplastic elastomer composition has an extremely excellent recycle property and an improved compression set, to thereby achieve high industrial-applicability and provide great worth to environment conservation.

### BACKGROUND OF THE INVENTION

1. Field of the Invention

The present invention relates to a thermoplastic elastomer composition having characteristics capable of repeating formation of crosslinking and dissociation of crosslinking with temperature change (hereinafter, also simply referred to as “recycle property”). In particular, the present invention relates to a thermoplastic elastomer composition having excellent recycle property and an improved compression set.

2. Description of the Related Arts

In recent years, reusage of waste materials is desired in view of environmental protection and resource saving. Vulcanized rubbers have stable three-dimensional networks in which polymer chain and vulcanizing agent are covalently bonded, and therefore show very strong strength, but are difficult to re-mold and reuse due to strongly covalent bond crosslinking. On the other hand, thermoplastic elastomers utilizing physical crosslinking state do not require complicated vulcanization and molding steps including pre-molding and the like, and therefore can easily be molded by heat melting.

Thermoplastic elastomer comprising a resin component and a rubber component, in which a crystal resin component forms a hard segment which serves as crosslinking point of a three-dimensional structure at room temperature to thereby prevent thermoplastic deformation of a rubber component (soft segment) whereby the thermoplastic elastomer plastically deforms by softening or fusion of the resin component with rising a temperature, is known as the representative example of such thermoplastic elastomers. However, such type of thermoplastic elastomers is liable to decrease rubber elasticity because of containing a resin component. For this reason, materials that do not contain a resin component and can impart thermoplasticity are demanded.

To solve the above problem, the inventors of the present invention previously proposed that an elastomer composition comprising an elastomer having a reaction site capable of forming hydrogen bonds and a compound having a reaction site capable of forming hydrogen bond together with the reaction site of the elastomer can repeats formation of crosslinking and dissociation of crosslinking by temperature difference utilizing hydrogen bond (JP 11-209524 A). Further, the inventors of the present invention proposed a hydrogen-bonding thermoplastic elastomer comprising an elastomeric polymer having a carbonyl-containing group and a heterocyclic amine-containing group in side chains, which is expected to have the similar effect in JP 2000-169527 A. JP 8-239583 A describes metal-containing organic polymer material containing compounds having specified metal elements and organic polymers having a carbonyl-containing group and a nitrogen-containing heterocycle-containing group in side chains, wherein the nitrogen-containing heterocycle-containing ring-containing group is bonded to the main chain directly or through an organic group at a 2-position counted from nitrogen atom. Those elastomer compositions or metal-containing organic polymer materials can sufficiently show melt flowability at a molding temperature of a thermoplastic resin such as olefin-based resin without modification, have excellent mechanical strength (breaking strength) at low temperature by the formation of crosslinking, and can repeatedly reformation of crosslinking and dissociation of crosslinking (softening).

Thermoplastic elastomers having such properties have very high value on industrial utilization and also very high value on environmental protection are expected for use as a material having further high crosslinking strength and having excellent recycle property, showing no change in physical properties even if formation of crosslinking and dissociation of crosslinking are repeated.

Incidentally, the above-mentioned thermoplastic elastomer (composition) or a metal-containing organic polymer material, with respect to material characteristics thereof, may have insufficient shape retention after loading and insufficient compression set at the time of unloading after loading for a predetermined time period.

Further, metal-containing organic polymer material described in JP 8-239583 A have had the problems such that strength is very small, and the properties are insufficient in using as an elastic material, such as using as a rubber material.

### SUMMARY OF THE INVENTION

As a technique of solving the above-mentioned problem, the inventors of the present invention have proposed a thermoplastic elastomer composition including: a thermoplastic elastomer having a carbonyl-containing group and a nitrogen-containing n-membered ring-containing group (n>3) on the side chain thereof in which the nitrogen-containing n-membered ring-containing group is bonded to a main chain at 3-position to n-position directly or indirectly through an organic group; and at least one metallic compound selected from those belonging to Groups 2A, 3A, 4A, 5A, 6A, 7A, 8, 1B, 2B, 3B, 4B, and 5B in the periodic table, the composition having hardness sufficient enough to be used as an elastic member, an improved shape retention, and an ability to repeat hardening and fluidization with a temperature change, without impairing an excellent recycle property (JP 2002-317122 A (Japanese Patent Application No. 2001-122598)).

However, in recent years, technological innovation, optimization of materials and so on, simplification and shortening of production process, and so on lead to demands for developed physical properties, characteristics, and so on of the thermoplastic elastomer composition. Under such present conditions, the thermoplastic elastomer having improved material characteristics such as compression set and having particularly excellent recycle property has been demanded.

Therefore, it is an object of the present invention to provide a thermoplastic elastomer composition having extremely excellent recycle property and improved compression set.

The inventors of the present invention have made extensive studies over and over, and found that when a metal element contained in a compound to be added in a thermoplastic elastomer having a carbonyl-containing group and a nitrogen-containing heterocycle on the side chain thereof is one belonging to Group 1 in the periodic table, a thermoplastic elastomer composition containing the compound and the thermoplastic elastomer can have an excellent recycle property and improved compression set. Thus, the present invention is completed.

Accordingly, the present invention provides the following items (I) to (VI):

(I) A thermoplastic elastomer composition including:

a thermoplastic elastomer having a carbonyl-containing group and a nitrogen-containing heterocycle in a side chain thereof; and

a compound containing a metal element belonging to Group 1 of the periodic table.

In the present invention, the term “Group 1 in the periodic table” means Group 1 in the periodic table based on the IUPAC recommendations in 1990.

(II) The thermoplastic elastomer composition according to the item (I), in which

the side chain has a structure represented by the following formula (1):

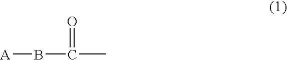

(wherein A represents the nitrogen-containing heterocycle, and B represents: a single bond; an oxygen atom, a nitrogen atom, or a sulfur atom; or an organic group which can include the atoms).

(III) The thermoplastic elastomer composition according to the item (I) or (II), in which

the side has a structure represented by one of the following formulae (2) and (3) and is bonded to a main chain at a-position or I-position:

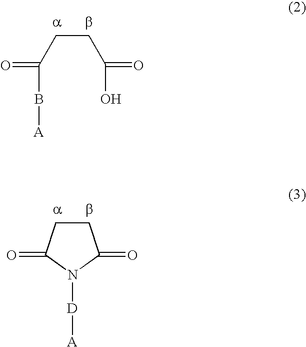

(wherein A represents the nitrogen-containing heterocycle, and B and D independently represent: a single bond; an oxygen atom, a nitrogen atom, or a sulfur atom; or an organic group which can include the atoms).

(IV) The thermoplastic elastomer composition according to any one of the items (I) to (III), in which

the metal element belonging to Group 1 of the periodic table, which is contained in the compound is selected from the group consisting of Li, Na, and K.

(V) The thermoplastic elastomer composition according to any one of the items (I) to (IV), in which

the nitrogen-containing heterocycle is selected from the group consisting of a triazole ring, a thiadiazole ring, a pyridine ring, and imidazole ring.

(VI) The thermoplastic elastomer composition according to any one of the items (I) to (V), further including:

at least one of carbon black and silica in 1 to 200 parts by weight with respect to 100 parts by weight of the thermoplastic elastomer.

### DETAILED DESCRIPTION OF THE PREFERRED EMBODIMENT

Hereinafter, the present invention will be described in detail.

A thermoplastic elastomer composition of the present invention (hereinafter, also simply referred to as “the composition of the present invention”) is characterized by including a compound that contains a metal element belonging to Group 1 in the periodic table (hereinafter, also simply referred to as “a compound that contains a metal element”). That is, the composition of the present invention includes a thermoplastic elastomer having a carbonyl-containing group and a nitrogen-containing heterocycle on the side chain thereof and a compound that contains a metal element belonging to Group 1 in the periodic table.

As the thermoplastic elastomer composition includes a compound that contains a metal element, an ionic bond, a coordinate bond, or the like is formed between the metal element included in the above-mentioned compound and the carbonyl group or nitrogen-containing heterocycle contained in a thermoplastic elastomer. As compared with a thermoplastic elastomer composition that does not contain the compound containing a metal element, the composition of the present invention has an improved crosslinking density. In addition, the ionic bond and the coordinate bond enhance the intermolecular interaction (hydrogen bond) with the carbonyl group and the nitrogen-containing heterocycle. Therefore, it is considered that the physical properties such as shape retention and hardness of the thermoplastic elastomer composition including such a compound containing the metal element will be improved.

Here, depending on the kind of the metal element contained in the above-mentioned compound, the crosslinking formed between the metal element and the carbonyl group or the nitrogen-containing heterocycle may become strong (permanent crosslinking), the crosslinking density may become too high, or the recycle property of the composition may be deteriorated.

However, in the case of using a metal element belonging to Group 1 in the periodic table as one contained in the above-mentioned compound, the valence of such a metal element is univalent and the coordination number thereof is small, so that supposedly, a strong ionic bond between molecules is hardly obtained between the metal element and the carbonyl group or the nitrogen-containing heterocycle. As a result, each of the ionic bond and the coordinate bond is not strongly formed unlike permanent crosslinking. Therefore, it is possible to retain the characteristics that enable the crosslinking dissociation or recombination with temperature change while increasing the strength thereof. Therefore, it is conceivable that the composition of the present invention including a compound that contains a metal element belonging to Group 1 of the periodic table is extremely superior in recycle property.

In addition, an improvement in the above-mentioned crosslinking density is achieved by containing a compound that contains a metal element belonging to Group 1 of the periodic table. In addition, the strength of crosslinking increases, so that an improvement in the compression set may be attained.

The compound that contains the metal element belonging to Group 1 in the periodic table may include one of the metal elements such as lithium (Li), sodium (Na), potassium (K), and rubidium (Rb). Among them, Li, Na, and K are preferable in that the recycle property and compression set of the composition can be improved and the compound that contains such a metal element can be easily obtained. Furthermore, Li is particularly preferable in that it has high crosslinking density and substantially an excellent recycle property.

The compound that contains a metal element belonging to Group 1 of the periodic table is not particularly limited as far as it contains a metal element belonging to Group 1 of the periodic table. For instance, such a compound may be saturated fatty acid salt having 1 to 20 carbon atoms such as formate, acetate, and stearate, unsaturated fatty acid salt such as (meth)acrylate, ether salt, nitrate, carbonate, hydrogencarbonate, chloride, oxide, hydroxide, and complex with diketone.

Here, the term “ether salt” means a compound such as metal alkoxide in which an oxygen atom bonded with hydrocarbon is directly bonded with the metal atom. In addition, the term “complex with diketone” means, for example, a complex in which 1,3-diketone (e.g., acetyl acetone) or the like is coordinated with the metal atom.

The compound that contains the metal element may be preferably saturated fatty acid salt having 1 to 20 carbon atoms such as acetate or stearate, ether salt (salt with alcohol having 1 to 12 carbon atoms), oxide, hydroxide, or complex with diketone, which contain a metal element belonging to Group 1 of the periodic table, in that it improves the compression set and the recycle property of the composition. Among them, the saturated fatty acid salt having 1 to 20 carbon atoms such as stearate, ether salt (salt with alcohol having 1 to 12 carbon atoms), or complex with diketone may be particularly preferable in that the above-mentioned compression set and the recycle property can be improved at higher level.

As the alcohol having 1 to 12 carbon atoms for forming the aforementioned ether salts, methanol, ethanol, propanol, isopropanol, butanol, 2-butanol, 1-methyl-2-butanol, t-butanol, octanol, decanol, dodecanol, phenol, or naphthol can be given.

As the saturated fatty acids having 1 to 20 carbon atoms for forming the aforementioned saturated fatty acid salts having 1 to 20 carbon atoms, acetic acid, propanoic acid (propionic acid), butyric acid, lauric acid, myristic acid, palmitic acid, or stearic acid can be given.

As the diketone used in the complex with diketone, for example, 1,3-diketone, 1,4-diketone, or 1,5-diketone can be given. More specifically, 1,3-diketone such as acetyl acetone, 2,4-hexanedione, benzoyl acetone, or dibenzoyl methane; 1,4-diketone such as acetonylacetone, or phenacylacetone; and 1,5-diketone such as 2,6-heptanedione can be given.

The composition of the present invention contains one or more compounds that each contain a metal element. If it contains two or more compounds, the mixing ratio of these compounds may be any ratio depending on the application of such a composition, the physical properties required for the composition, and so on.

The content of the compound that contains the metal element in the composition of the present invention is preferably 0.1 to 2.0 equivalents, more preferably 0.3 to 1.5 equivalents, much more preferably 1.0 equivalent with respect to the content of the nitrogen-containing heterocycle contained in the thermoplastic elastomer described below.

As far as the content falls within the above-mentioned range, the improvement effects on the compression set and the recycle property of the composition are particularly excellent.

In the thermoplastic elastomer composition of the present invention, furthermore, a compound that contains a metal element belonging to another group may be included as far as it contains the compound having a metal element belonging to Group 1 of the periodic table and it does not impair the effects of the present invention. The content of the compound that contains the metal element of other group is preferably 1 to 50 mol %, for example, with respect to the compound that contains the metal element belonging to Group 1 of the periodic table, but not specifically limited to such a content.

In addition, the compound that contains the metal element to be used in the present invention contains a metal element belonging to Group 1 of the periodic table. However, a metal element belonging to another group may be included in the compound that contains the metal element as far as it does not impair the effects of the present invention. The content of the metal element of other group in the compound that contains the metal element of other group and the metal element belonging to Group 1 of the periodic table is preferably 1 to 50 mol %, for example, with respect to the total metal elements in the compound, but not specifically limited to such a content.

The composition of the present invention includes a thermoplastic elastomer that contains a carbonyl-containing group and a nitrogen-containing heterocycle on the side chain.

The thermoplastic elastomer contains a carbonyl-containing group and a nitrogen-containing heterocycle on the side chain of an elastomeric polymer, which is a natural or synthetic polymer.

In the present invention, the term “side chain” means the side chain and the terminal of the elastomeric polymer. In addition, the phrase “the carbonyl-containing group and the nitrogen-containing heterocycle are included on the side chain” means that the carbonyl-containing group and the nitrogen-containing heterocycle are bonded (covalent bond) in a chemically stable state to the atoms (generally carbon atoms) that form the main chain of an elastomeric polymer.

The elastomeric polymer to be provided as a main chain of the thermoplastic elastomer is not specifically limited, but may be a natural polymer or a synthetic polymer generally known in the art. However, it is preferable to use a polymer having a glass transition temperature equal to or less than room temperature (25° C.), that is, elastomer. As this type of elastomeric polymer, specifically, for example, diene rubbers such as natural rubber (NR), isoprene rubber (IR), butadiene rubber (BR), 1,2-butadiene rubber (1,2-BR), styrene-butadiene rubber (SBR), acrylonitrile-butadiene rubber (NBR), chloroprene rubber, butyl rubber (isobutylene-isoprene rubber IIR), and ethylene-propylene-diene rubber (EPDM) and those hydrogenated diene rubbers; olefin rubbers such as ethylene-propylene rubber (EPM), ethylene-butene rubber (EBM), chlorosulfonated polyethylene, acrylic rubber, fluorocarbon rubber, polyethylene rubber, and polypropylene rubber; epichlorohydrin rubber; polysulfide rubber; silicone rubber; and urethane rubber can be given.

Further, the elastomeric polymer to form a main chain may be an elastomeric polymer containing a resin component (thermoplastic elastomer). For example, polystyrene elastomeric polymers (e.g., SBS, SIS or SEBS), polyolefin elastomeric polymers, polyvinyl chloride elastomeric polymers, polyurethane elastomeric polymers, polyester elastomeric polymers or polyamide elastomeric polymers, or hydrogenated elastomeric polymers of those polymer can be given.

The elastomeric polymer may be either liquid or solid. Molecular weight of the elastomeric polymer is not particularly limited, and can be appropriately determined according to the application of the composition, and the physical property such as crosslinking density required for the composition.

In the case where flowability when heating the composition of the present invention (decrosslinking) is considered important, the elastomeric polymer is preferably liquid. For example, in diene rubbers such as isoprene rubber or butadiene rubber, a weight average molecular weight is preferably 1,000 to 100,000, more preferably about 1,000 to 50,000. On the other hand, when strength of the composition of the present invention is considered important, the elastomeric polymer is preferably solid rubber. For example, in diene rubbers such as isoprene rubber or butadiene rubber, a weight average molecular weight is preferably more than 100,000, more preferably 500,000 to 1,500,000.

In the present invention, two or more of the above-mentioned elastomeric polymers can be used in mixture. In this case, the mixing ratio thereof may be any ratio depending on the application of the composition, physical properties required for the composition, and so on.

Furthermore, the glass transition temperature of the elastomeric polymer to be used in the present invention is preferably 25° C. or less. It is preferable that at least one of the glass transition temperatures is 25° C. or less when the polymer has two or more glass transition temperatures or two or more polymers are used in combination. In this range, the resulting molded product shows the rubber-like elasticity at room temperature.

It is particularly preferable that the elastomeric polymers are diene rubbers such as natural rubber (NR), isoprene rubber (IR), butadiene rubber (BR), 1,2-butadiene rubber (1,2-BR), styrene-butadiene rubber (SBR), ethylene-propylene-diene rubber (EPDM), and butyl rubber (IIR), and those hydrogenated diene rubbers; or olefin rubbers such as ethylene-propylene rubber (EPM) and ethylene-butene rubber (EBM). Each of the polymers has a glass transition temperature of 25° C. or less, showing the rubber-like elasticity at room temperature. Also, modification in maleic anhydride described below can easily occur when diene rubbers are used. The composition has more excellent tensile strength at the time of crosslinking thereof when olefin rubbers are used, so that the deterioration of the composition can be inhibited.

In the present invention, although not specifically limited, the bound styrene content in the styrene-butadiene rubber (SBR), the hydrogenation ratio of a hydrogenated elastomeric polymer, and so on can be adjusted to any ratio depending on the application of the composition of the present invention, the physical properties required for the composition of the present invention, and so on.

When EPM, EPDM, and EBM are used for the main chain of a thermoplastic elastomer, the content of ethylene thereof is preferably 10 to 80 mol %, more preferably 40 to 60 mol %. If the content falls within this range, the resulting composition may be satisfactory in terms of compression set and mechanical strength.

The thermoplastic elastomer of the present invention has a carbonyl-containing group and a nitrogen-containing heterocycle in the side chain of an elastomeric polymer.

The carbonyl-containing group may be any group as far as it contains a carbonyl group, for example, an amide group, an ester group, an imide group, a carboxy group, or a carbonyl group. The compound in which such a group can be introduced is not particularly limited but may be, for example, ketones, carboxylic acids and the derivatives thereof.

The carboxylic acids may be, for example, organic acid having a saturated or unsaturated hydrocarbon group. The hydrocarbon group may be any of aliphatic, alicyclic, aromatic, and so on. In addition, for example, the carboxylic acid derivatives include carboxylic acid anhydrides, amino acids, thiocarboxylic acids (mercapto group-containing carboxylic acids), esters, amino acids, ketones, amides, imides, dicarboxylic acids, and the monoesters thereof.

Specific examples of carboxylic acids and the derivatives thereof include: carboxylic acids, such as malonic acid, maleic acid, succinic acid, glutaric acid, phthalic acid, isophthalic acid, terephthalic acid, p-phenylenediacetic acid, p-hydroxybenzoic acid, p-aminobenzoic acid, mercaptoacetic acid, propionic anhydride, or benzoic anhydride, and substituent-containing carboxylic acids; acid anhydrides such as succinic anhydride, maleic anhydride, glutaric anhydride, or phthalic anhydride; aliphatic esters such as maleic ester, malonic ester, succinic ester, glutaric ester or ethyl acetate; aromatic esters such as phthalic acid ester, isophthalic acid ester, terephthalic acid ester, ethyl m-aminobenzoate or methyl p-hydroxybenzoate; ketones such as quinone, anthraquinone or naphthoquinone; amino acids such as glycine, tyrosine, vicine, alanine, valine, leucine, serine, threonine, lysine, asparaginic acid, glutamic acid, cysteine, methionine, proline or N-(p-aminobenzoyl)-β-alanine; amides such as maleinamide, maleinamic acid (maleic acid monoamide), succinic monoamide, 5-hydroxy valeramide, N-acetylethanol amine, N,N′-hexamethylenebis(acetamide), malonamide, cycloserine, 4-acetamide phenol or p-acetamidobenzoic acid; and imides such as maleimide ,succinimide or urazole(3,5-dioxo-1,2,4-triazolidine).

Of those, as the compound in which the carbonyl group (carbonyl-containing group) can be introduced, cyclic acid anhydrides such as succinic anhydride, maleic anhydride, glutaric anhydride, or phthalic anhydride; and imides such as 3,5-dioxo-1,2,4-triazolidine are preferable, and particularly, maleic anhydride and 3,5-dioxo-1,2,4-triazolidine are more preferable.

The nitrogen-containing heterocycle contained in the side chain of the thermoplastic elastomer can be introduced into the main chain directly or indirectly though an organic group.

The applicable nitrogen-containing heterocycle containing a nitrogen atom in its heterocycle may additionally contain a hetero atom such as sulfur atom, oxygen atom, or phosphorus atom except a nitrogen atom in the heterocycle. Here, the heterocycle compound is used because when the heterocycle structure is formed, tensile strength of the composition is increased as a result of an increase in the strength of hydrogen bond that forms the crosslinking described later.

Further, the aforementioned heterocycle may have a substituent. Examples thereof include: alkyl groups such as methyl group, ethyl group, (iso)propyl group or hexyl group; alkoxy groups such as methoxy group, ethoxy group or (iso)propoxy group; groups including halogen atoms such as fluorine atom, chlorine atom, bromine atom or iodine atom; cyano groups; amino groups; aromatic hydrocarbon groups; ester groups; ether groups; acyl groups; or thioether groups. Those groups can be used in combination.

Substitution position of those substituents is not particularly limited, and the number of substituents is also not limited. The heterocycle may or may not have aromaticity, but preferably has the aromaticity in that tensile strength at the time of crosslinking is further increased to improve the strength of the resulting product.

It is preferable to use 5- or 6-membered ring as nitrogen-containing heterocycle.

Specific examples of nitrogen-containing heterocycles include: pyrrololine, pyrrolidone, oxyindole(2-oxyindole), indoxyl (3-oxyindoxyl), dioxyindole, isatin, indolyl, phthalimidine, β-isoindigo, monoporphyrin, diporphyrin, triporphyrin, azaporphyrin, phthalocyanine, hemoglobin, uroporphyrin, chlorophyll, phylloerythlin, imidazole, pyrazole, triazole, tetrazole, benzimidazole, benzopyrazole, benzotriazole, imidazoline, imidazolone, imidazolidone, hydantoin, pyrazoline, pyrazolone, pyrazolidine, indazole, pyridoindole, purine, cinnoline, pyrrole, pyrroline, indole, indoline, oxindole, carbazole, phenothiazine, indolenine, isoindole, oxazoles, thiazoles, isooxazoles, isothiazole, oxadiazole, thiadiazole, oxatriazole, thiatriazole, phenanthroline, oxazine, benzoxazine, phthalazine, pteridine, pyrazine, phenazine, tetrazine, benzoxazole, benzoisooxazole, anthranyl, benzothiazole, benzofurazane, pyridine, quinoline, isoquinoline, acridine, phenanthridine, anthrazoline, naphthilidine, thiazine, pyridazine, pyrimidine, quinazoline, quinoxaline, triazine, histidine, triazolidine, melamine, adenine, guanine, thymine, cytosine, urazole and the like. Among these nitrogen-containing heterocycles, in particular, with respect to nitrogen-containing 5-membered ring, the following compounds may be preferably exemplified. The compounds may have various kinds of substituents as described above, or may be the ones having the hydrogen atom added thereto (the compounds may be reduced) or removed therefrom (the compounds may be oxidized).

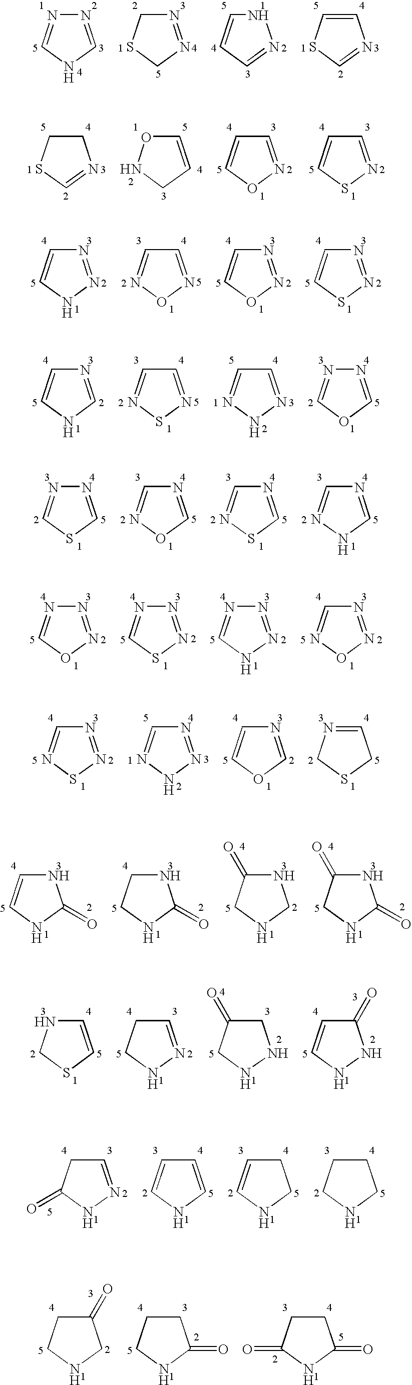

As for the nitrogen-containing 6-membered ring, the following compounds may be preferably exemplified. In this case, such a compound may have various kinds of substituents described above, or may be the one subjected to the addition or removable of a hydrogen atom.

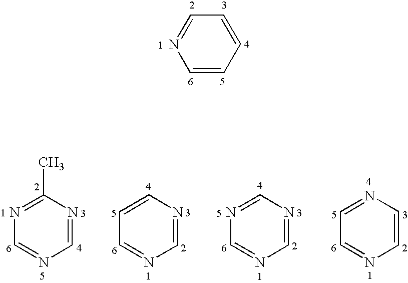

In addition, a compound prepared by a condensation between the above-mentioned nitrogen-containing heterocycle and a benzene ring or a nitrogen-containing heterocycle may be used. For example, the following condensed ring can be preferably used. Such a compound may also include the various kinds of substituents described above, or the hydrogen atom may be added or removed.

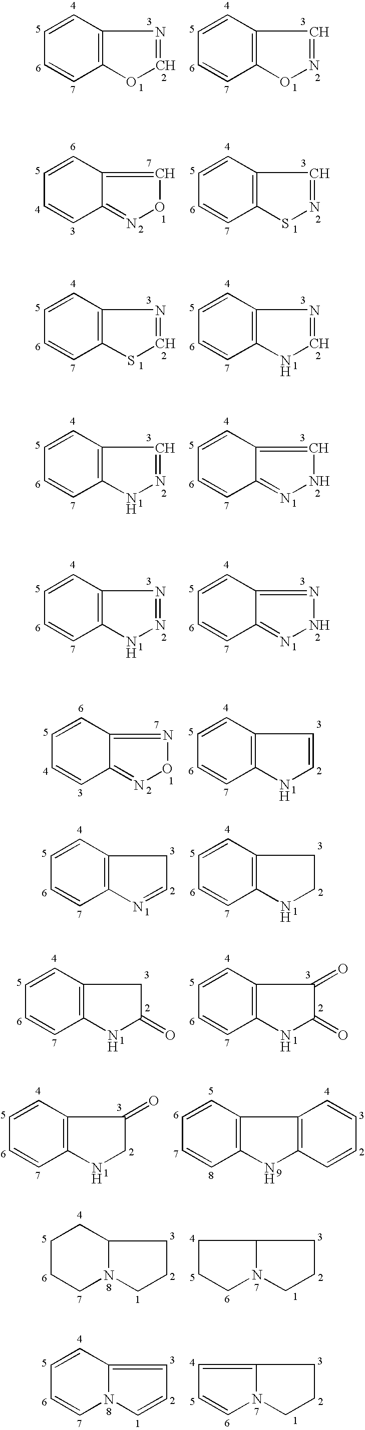

Among the nitrogen-containing heterocycles described above, the one having triazole ring, pyridine ring, thiadiazole ring or imidazole ring is preferable because it provides a thermoplastic elastomer composition with superior mechanical strength, shape retention, compression set, workability, and recycle properties.

In the thermoplastic elastomer of the present invention, the above-mentioned nitrogen-containing heterocycle is introduced into a main chain thereof directly or indirectly through an organic group, preferably introduced into the main chain through the organic group.

In addition, as for the thermoplastic elastomer of the present invention, the carbonyl-containing group and the nitrogen-containing heterocycle may form independent side chains and may be introduced into main chain. Alternatively, the carbonyl-containing group and the nitrogen-containing heterocycle may be bonded on one side chain through different groups and introduced into the main chain.

The carbonyl-containing group and the nitrogen-containing heterocycle may be preferably introduced into the above-mentioned polymer main chain through an organic group as a side chain represented by the following formula (1).

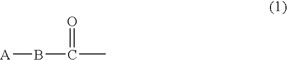

(wherein A represents a nitrogen-containing heterocycle, and B represents: a single bond; an oxygen atom, a nitrogen atom, or a sulfur atom; or an organic group which may include the atoms)

Here, to be specific, the nitrogen-containing heterocycle A is the nitrogen-containing heterocycle described above.

“B” represents a single bond; an oxygen atom, a nitrogen atom, or a sulfur atom; or an organic group that may contain those atoms. Specifically, indicated by B is, for example, a single bond; an oxygen atom, a sulfur atom, or an amino group NR′ (R′ is a hydrogen atom or an alkyl group having 1 to 10 carbon atoms); an alkylene group or aralkylene group having 1 to 20 carbon atoms, which may contain those atoms; an alkylene ether group having 1 to 20 carbon atoms (alkylene oxy group, such as —O—CH₂CH₂— group), an alkylene amino group (such as —NH—CH₂CH₂— group), or an alkylene thioether group (alkylene thio group, such as —S—CH₂CH₂-group), which contains those atoms on the terminal; or an aralkylene ether group (aralkylene oxy group), an aralkylene amino group, or aralkylene thioether group, having those atoms on its terminal and having 1 to 20 carbon atoms.

Here, as the alkyl group having 1 to 10 carbon atoms of the amino group NR′, there can be exemplified methyl group, ethyl group, propyl group butyl group, pentyl group, hexyl group, heptyl group, octyl group, nonyl group, decyl group, phenyl group, or tolyl group including isomers.

It is preferable that the oxygen atom, the sulfur atom, and the amino group of B described above, or an oxygen atom, a nitrogen atom, and a sulfur atom in an alkylene ether or aralkylene ether group or the like having 1 to 20 carbon atoms, in which an oxygen atom, a nitrogen atom, or a sulfur atom may be included, are combined with the adjacent carbonyl group to form an ester group, an amide group, an imide group, and a thioester group, respectively.

Among them, in particular, B is preferably one that forms a conjugate system, such as oxygen atom, sulfur atom, or amino group, or one having them on the terminal thereof, such as an alkylene ether group, an alkylene amino group, or an alkylene thioether group having 1 to 20 carbon atoms. It is particularly preferable to use amino group (NH), alkylene amino group (—NH—CH₂— group, —NH—CH₂CH₂— group, or —NH—CH₂CH₂CH₂— group), and alkylene ether group (—O—CH₂-group, —O—CH₂CH₂— group, or —O—CH₂CH₂CH₂— group).

It is preferable that the carbonyl-containing group and the nitrogen-containing heterocycle are introduced as one side chain represented by the following formula (2) or (3) into the main chain of the above-mentioned polymer at an α-position or a β-position.

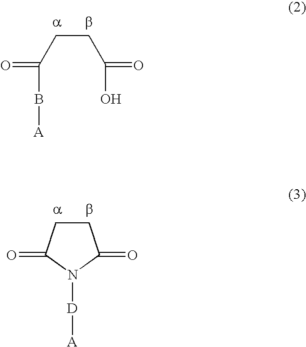

(wherein A represents a nitrogen-containing heterocycle, and B and D independently represent: a single bond; an oxygen atom, a nitrogen atom, or a sulfur atom; or an organic group which may include those atoms) Here, the nitrogen-containing heterocycle A is basically similar to the nitrogen-containing heterocycle A of the above-mentioned formula (1). B and D are independently and basically similar to B of the above-mentioned formula (1).

However, among the examples of B of the above-mentioned formula (1), D in the formula (3) is preferably a single bond; or an alkylene group or aralkylene group having 1 to 20 carbon atoms, which may include an oxygen atom, a nitrogen atom, or a sulfur atom. More particularly, the single bond is preferable. In other words, with the imide nitrogen of the above-mentioned formula (3), it is preferable to form an alkylene amino group or an aralkylene amino group having 1 to 20 carbon atoms, which may include an oxygen atom, a nitrogen atom, or a sulfur atom. In particular, it is preferable to directly bond imide nitrogen of the above-mentioned formula (3) with a nitrogen-containing heterocycle (single bond). Specifically, D is a single bond; an alkylene ether, or alkylene ether group having 1 to 20 carbon atoms, having an oxygen atom, a sulfur atom or an amino group in terminal; or methylene group, ethylene group, propylene group, butylene group, hexylene group, phenylene group, xylylene group, or the like, including isomers.

A ratio between the above-mentioned carbonyl-containing group and the above-mentioned nitrogen-containing heterocycle contained in the thermoplastic elastomer is not particularly limited, but when it is 2:1 (in the case of the imide structure of the above-mentioned formula (3), 1:1), complementary interaction is easy to obtain and, in addition, the elastomer can be easily produced, so that the ratio is preferable.

The side chains having both carbonyl-containing group and nitrogen-containing heterocycle are preferably introduced at a ratio (induction ratio) of 0.1 to 50 mol %, more preferably 1 to 30 mol % with respect to 100 mol % of constituent monomer of the main chain.

If it is less than 0.1 mol %, a sufficient strength at the time of crosslinking cannot be obtained in some cases. If it is higher than 50 mol %, the crosslinking density increases and the rubber elasticity tends to be impaired. In other words, within the above-mentioned range, interaction between side chains of the thermoplastic elastomer occurs between molecules or inside a molecule. The crosslinking by above-mentioned interaction is formed in a well-balanced manner, so that an extremely high tensile strength at the time of crosslinking is obtained with good recycle property when the composition is prepared.

When the carbonyl-containing group and the nitrogen-containing heterocycle are introduced independently, both groups may be considered as a pair on the basis of the ratio of the carbonyl-containing group and the nitrogen-containing heterocycle. If one of these groups is excessively contained, the group with higher content may be considered as criteria.

The induction ratio may be represented such that the amount of monomer introduced in the side chain portion is almost 0.1 to 50 units with respect to 100 units of ethylene and propylene monomer, for example when the main chain portion is an ethylene-propylene rubber.

The glass transition temperature of the thermoplastic elastomer is preferably 25° C. or less. When the elastomer has two or more glass transition temperatures or when two or more elastomers are used together, at least one of the glass transition temperatures is preferably 25° C. or less. When the glass transition temperature is 25° C. or less, the molded product shows a rubber-like elasticity at room temperature.

A method of producing the thermoplastic elastomer is not particularly limited, so that a general method can be used.

Among the thermoplastic elastomers, for example, one having the carbonyl-containing group and the nitrogen-containing heterocycle in the same side chain can be obtained by reacting a carbonyl-containing group modified polymer of the elastomeric polymer with a compound in which a nitrogen-containing heterocycle can be introduced.

Specifically, diene rubber such as butadiene rubber and a toluene solution that contains maleic anhydride or mercaptoacetic acid, or olefin rubber such as EPM, for example, a-olefin of propylene and a toluene solution that contains mercaptoacetic acid, are reacted at room temperature or under heating in a nitrogen atmosphere to obtain an elastomer modified with a carbonyl-containing group. Subsequently, the resulting elastomer is reacted with a compound in which a nitrogen-containing heterocycle can be introduced, to thereby obtain the target product.

Here, the term “compound in which a nitrogen-containing heterocycle can be introduced” used herein may refer to a nitrogen-containing heterocycle itself, or a nitrogen-containing heterocycle having a substitute (e.g., hydroxyl group, thiol group, and amino group) to be reacted with a carbonyl-containing group such as maleic anhydride. In addition, a part of or total amount of the carbonyl-containing group of the carbonyl-containing group modified elastomer may be reacted with the compound in which a nitrogen-containing heterocycle can be introduced. Here, the term “part” means preferably 1 mol % or more, more preferably 50 mol % or more, still more preferably 80 mol % or more with respect to 100 mol % of the carbonyl-containing group. In this range, the effects resulting from the introduction of nitrogen-containing heterocycle can be enhanced, so that the tensile strength at the time of crosslinking can be more increased. It is particularly preferable to react the total amount (100 mol %) of the carbonyl-containing group with the compound because of excellent tensile strength, compression set, and workability.

The elastomer modified with the carbonyl-containing group to be used may be commercially available, for example, maleic anhydride-modified isoprene rubbers such as LIR-403 (manufactured by Kuraray Co., Ltd.) and LIR-410A (manufactured by Kuraray Co., Ltd., trial product), carboxy-modified isoprene rubbers such as LIR-410 (manufactured by Kuraray Co., Ltd.), carboxyl-modified nitrile rubbers such as Krynac 110, 221, and 231 (manufactured by Polysar Ltd.), carboxy-modified polybutenes such as CPIB (manufactured by Nippon Petrochemicals Co., Ltd.), HRPIB (manufactured by Nippon Petrochemicals Co., Ltd., trial product in laboratory), maleic anhydride-modified ethylene-propylene rubbers such as Nucrel (manufactured by Du Pont-Mitsui Fluorochemicals Co., Ltd.), Yukaron (manufactured by Mitsubishi Chemical Co., Ltd.) and Tafiner M (MA8510, manufactured by Mitsui Chemicals Co., Ltd.), maleic anhydride-modified ethylene-butene rubbers such as Tafiner M (MA7020, manufactured by Mitsui Chemicals Co., Ltd.), maleic anhydride modified polyethylenes such as Admer (LF128, etc., manufactured by Mitsui Chemicals Co., Ltd., ADTEX series (maleic anhydride modified EVA), manufactured by Japan Polyolefines Co., Ltd., HPR series (maleic anhydride modified EEA), manufactured by Du pont-Mitsui Polychemicals co., Ltd., bondfast series (maleic anhydride modified ENA), manufactured by Sumitomo Chemical Co., Ltd., dumiran series (maleic anhydride modified EVOH), manufactured by Takeda Chemical Industries Co., Ltd.), maleic anhydride-modified polypropylenes such as Admer (QB550, etc., manufactured by Mitsui Chemicals Co., Ltd.), and so on.

In addition, in the present invention, after reaction between the compounds in which the carbonyl-containing group and the nitrogen-containing heterocycle can be respectively introduced, it may be introduced into the side chain of the elastomeric polymer.

In the case of synthesis for the thermoplastic elastomer in which a carbonyl-containing group and a nitrogen-containing heterocycle are independently included in side chains thereof, a monomer capable of forming the main chain of the elastomeric polymer and a monomer containing a carbonyl-containing group, and a monomer containing a nitrogen-containing heterocycle are copolymerized together, to thereby produce the thermoplastic elastomer directly. Alternatively, a main chain (elastomeric polymer) may be formed in advance by polymerization or the like, followed by a graft modification with a compound in which the above-mentioned carbonyl-containing group and the above-mentioned nitrogen-containing heterocycle can be respectively introduced.

In each of the above-mentioned producing methods, whether each group in the side chain of the thermoplastic elastomer is bonded independently of other group or is bonded with other group may be confirmed by the generally-used analyzing means such as NMR or IR spectrum.

In the above-mentioned producing method for thermoplastic elastomer, as a preferable method, a carbonyl-containing group modified elastomeric polymer in which a carbonyl-containing group is introduced is prepared through the synthesis at first, followed by reacting the resulting elastomeric polymer with a compound in which a nitrogen-containing heterocycle can be introduced, to thereby introduce the nitrogen-containing heterocycle thereinto. In particular, an elastomeric polymer having cyclic acid anhydride on its side chain is brought into a reaction with a compound in which a nitrogen-containing heterocycle can be introduced at a temperature that allows a chemical reaction (e.g., a covalent bond or an ionic bond) between the compound in which the nitrogen-containing heterocycle can be introduced and the cyclic acid anhydride group. Therefore, it is preferable to introduce both the carbonyl-containing group and the nitrogen-containing heterocycle into the main chain of the elastomeric polymer (i.e., the cyclic acid ring opens). Details of the production of such an elastomer are disclosed in JP 2000-169527 A.

The nitrogen heterocycle of the present invention is assumed as “nitrogen-containing n-membered ring compound (n ≧3)” for convenience of description, and a bonding position of nitrogen-containing heterocycle is explained.

The bonding positions (1- to n-positions) described below are based on the IUPAC nomenclature. For instance, in the case of a compound having three nitrogen atoms having unshared electron pair, bonding positions are defined based on the order according to the IUPAC nomenclature. Specifically, the bonding positions have been shown in the nitrogen-containing heterocycle of the 5-membered ring, the 6-membered ring, and the condensed ring, respectively.

In the thermoplastic elastomer, the bonding position of the nitrogen-containing n-membered ring compound to be bonded to a main chain directly or indirectly through an organic group is not particularly limited, so that it may be bonded to any of bonding positions (1- to n-positions). Examples of preferable position include 1-position or 3- to n-positions.

When the number of nitrogen atoms included in the nitrogen-containing heterocycle is 1 (e.g., a pyridine ring), a chelate tends to be formed in the molecule, resulting in a decrease in the physical properties such as tensile strength at the time of forming the composition. Thus, 1- or 2-position is not preferable.

When the nitrogen-containing n-membered ring compound which contains two or more nitrogen atoms is bonded at 1-position or 3- to n-positions with the main chain, even if the carbonyl group and the nitrogen-containing heterocycle are in the same side chain, the distance between the nitrogen atom in the nitrogen-containing heterocycle and the carbonyl group is large enough to make it difficult to form a chelate in the molecule. Thus, an improvement in crosslinking strength (tensile strength at the time of forming the composition) can be attained by formation of the intermolecular chelate and ionic bond. In addition, the crosslinking density can be also improved. When the nitrogen-containing heterocycle which contains two or more nitrogen atoms is a 5-membered ring, 3- or 4-position is preferable; 3-position is particularly preferable.

By selecting the bonding position of the nitrogen-containing heterocycle, in the thermoplastic elastomer, the crosslinking is easily formed through a hydrogen bond, an ionic bond, or a coordinate bond between the molecules of the thermoplastic elastomers or between the elastomer and the compounds containing metal ions. Therefore, the resulting composition has an excellent recycle property and an excellent compression set.

The composition of the present invention contains one or more thermoplastic elastomers. When two or more thermoplastic elastomers are contained, the mixing ratio thereof may be any ratio depending on the application of the resulting composition, the physical properties required for the composition, and the like.

The composition of the present invention may preferably contain carbon black and/or silica as a reinforcing agent.

The content of the carbon black (when the carbon black is used solely) is 1 to 200 parts by weight, preferably 20 to 100 parts by weight, more preferably 30 to 80 parts by weight with respect to 100 parts by weight of the thermoplastic elastomer.

The kinds of carbon black may favorably selected depending on the application thereof. In general, the carbon black can be classified into hard carbon and soft carbon depending on the particle sizes of the carbon black.

The soft carbon has a low reinforcing property to rubber, while the hard carbon has a high reinforcing property to rubber. In the present invention, it is particularly preferable to use the hard carbon having high reinforcing property.

The silica may include, although not particularly limited, fumed silica, calcined silica, precipitated silica, crushed silica, fused silica, diatomaceous earth, and so on. The content of the silica (when the silica is used solely) is 1 to 200 parts by weight, preferably 20 to 100 parts by weight, more preferably 30 to 80 parts by weight with respect to 100 parts by weight of thermoplastic elastomer. Among them, the precipitated silica is preferable.

When silica is used as reinforcing agent, silane coupling agents can be used together. As the silane coupling agents, for example, bis (triethoxysilylpropyl) tetrasulfide (Si69), bis (triethoxysilylpropyl) disulfide (Si75), γ-mercaptopropyl trimethoxysilane, or vinyltrimethoxysilane can be given.

In the case of using the silica and the carbon black in combination with the elastomer, the content (the total amount of carbon black and silica) is 1 to 200 parts by weight, preferably 20 to 100 parts by weight, more preferably 30 to 80 parts by weight with respect to 100 parts by weight of the thermoplastic elastomer.

The composition of the present invention may further contain, as needed, a polymer other than the elastomeric polymer of the present invention or various additives such as a reinforcing agent except the carbon black and the silica as described above, an anti-aging agent, an antioxidant, a pigment (dye), a plasticizer, a thixotropic agent, a UV absorber, a fire retardant, a solvent, a surfactant (including a leveling agent), a dispersant, a dehydrating agent, a anticorrosives, a tackifier, an antistatic agent, and a filler.

The above-mentioned additives and so on may be those generally used in the art, and some of specific examples will be listed below. However, the additives are not limited to the following only provided for exemplification.

The polymers, except for the thermoplastic elastomer used in the present invention, may preferably include those having the glass transition temperature of 25° C. or less by the above-mentioned reason, more preferably any one selected from the polymers used in the main chain of the present invention. More preferably, the polymers include natural rubber (NR), isoprene rubber (IR), butadiene rubber (BR), 1,2-butadiene rubber, styrene-butadiene rubber (SBR), acrylonitrile-butadiene rubber (NBR), butyl rubber (IIR), ethylene-propylene-diene rubber (EPDM), ethylene-propylene rubber (EPM), and ethylene-butene rubber (EBM). Among them, in particular, it is preferable to use a polymer having no unsaturated bond of IIR, EPM, or EBM, or a polymer with few unsaturated bonds (e.g., EPDM). In addition, other polymers having portions capable of forming hydrogen bonds, such as polyester, polylactone, and polyamide are preferable. One kind or two or more kinds of those polymers may be contained. The content of the polymer is preferably 0.1 to 100 parts by weight, more preferably 1 to 50 parts by weight with respect to 100 parts by weight of the thermoplastic elastomer.

Reinforcing agents other than the carbon black and the silica include, for example, iron oxide, zinc oxide, aluminum oxide, titanium oxide, barium oxide, magnesium oxide, calcium carbonate, magnesium carbonate, zinc carbonate, Roseki clay, kaolin clay, and calcined clay. The content thereof is preferably 20 to 100 parts by weight, more preferably 30 to 80 parts by weight with respect to 100 parts by weight of the thermoplastic elastomer.

As the anti-aging agent, for example: hindered phenol type compounds, and aliphatic or aromatic hindered amine type compounds can be given. The content thereof is preferably 0.1 to 10 parts by weight, more preferably 1 to 5 parts by weight, with respect to 100 parts by weight of the thermoplastic elastomer.

As the antioxidant, for example, butyl hydroxytoluene (BHT) or butyl hydroxyanisole (BHA) can be given. The content thereof is preferably 0.1 to 10 parts by weight, more preferably 1 to 5 parts by weight, with respect to 100 parts by weight of thermoplastic elastomer.

As the pigment, for example, inorganic pigments such as titanium dioxide, zinc oxide, ultramarine blue pigment, red iron oxide, lithopone, lead, cadmium, iron, cobalt, aluminum, chlorides or sulfates; and organic pigments such as azo pigments or copper phthalocyanine pigments can be given. The content thereof is preferably 0.1 to 10 parts by weight, more preferably 1 to 5 parts by weight, with respect to 100 parts by weight of thermoplastic elastomer.

As the plasticizer, for example, derivatives of benzoic acid, phthalic acid, trimellitic acid, pyromellitic acid, adipic acid, sebacic acid, fumaric acid, maleic acid, itaconic acid, citric acid, and the like, and polyester, polyether, and epoxy can be given.

As the thixotropic agent, bentone, silicic anhydride, silicic derivatives, or urea derivatives can be given.

As the UV absorber, for example, 2-hydroxybenzophenon, benzotriazole, salicylate can be given.

As the fire retardant, for example, phosphorus compounds such as TCP; halogen compounds such as chlorinated paraffin, and perchloropentacyclodecane; antimony compounds such as antimony oxide; or aluminum hydroxides can be given.

The solvents include, for example: hydrocarbons such as hexane and toluene; halogenated hydrocarbons such tetrachloromethane; ketones such as acetone and methyl ethyl ketone; ethers such as diethyl ether and tetrahydrofuran; and esters such as ethyl acetate.

The surfactants (leveling agents) include, for example, polybutyl acrylate, polydimethyl siloxane, modified silicon compounds, and fluorine-containing surfactants.

The dehydrating agents include vinyl silane and so on.

The anticorrosives includes, for example, zinc phosphate, tannic acid derivative, phosphate, basic sulfonate, and various kinds of anti-corrosive pigments.

The tackifiers include, for example, well-known silane coupling agents, silane compounds having alkoxysilyl groups, titanium coupling agent, and zirconium coupling agent. More specifically, for example, trimethoxy vinyl silane, vinyl triethoxy silane, vinyl tris(2-methoxy ethoxy) silane, γ-methacryloxypropyl trimethoxysilane, and 3-glycidoxypropyl trimethoxysilane are given.

The antistatic agents include, in general, quaternary ammonium salt or hydrophilic compounds such as polyglycol or ethylene oxide derivatives.

The content of the plasticizer is preferably 0.1 to 50 parts by weight, more preferably 1 to 30 parts by weight with respect to 100 parts by weight of the above-mentioned thermoplastic elastomer. The content of other additives are preferably 0.1 to 10 parts by weight, more preferably 1 to 5 parts by weight.

Some of thermoplastic elastomers of the present invention are capable of self crosslinking. However, within the scope of the present invention, a curing agent, a accelerator activator, vulcanization accelerator, a retarder, or the like can be used together.

As the curing agents, for example, curing agents such as sulfurs, organic peroxides, metallic oxides, phenolic resins, or quinone dioxime can be given.

As the curing agents of sulfurs, for example, powdered sulfur, precipitating sulfur, highly dispersible sulfur, surface-treated sulfur, insoluble sulfur, dimorpholine disulfide, or alkylphenol disulfide can be given.

As the curing agents of organic peroxides, for example, benzoylperoxide, t-butyl hydroperoxide, 2,4-dichlorobenzoylperoxide, 2,5-dimethyl-2,5-di(t-butylperoxide)hexane, and 2,5-dimethylhexane-2,5-di(peroxyl benzoate) can be given.

As other examples, magnesium oxide, litharge (lead oxide), p-quinone dioxime, tetrachloro-p-benzoquinone, p-dibenzoylquinone dioxime, poly-p-dinitrosobenzene, or methylene dianiline can be given.

As the accelerator activators, zinc oxide, magnesium oxide, amines, fatty acids such as acetyl acid, propionic acid, butanoic acid, stearic acid, acrylic acid or maleic acid; and zinc salts of fatty acid such as zinc acetylate, zinc propionate, zinc butanoate, zinc stearate, zinc acrylate or zinc maleate can be given.

As the vulcanization accelerator, for example, thiurams such as tetramethylthiuram disulfide (TMTD) or tetraethylthiuram disulfide (TETD); aldehyde-ammonias such as hexamethylenetetramine; guanidines such as diphenylguanidine; thiazoles such as dibenzothiazyldisulfide (DM); and sulfenamides such as cyclohexylbenzothiazyl sulfenamide can be given. Alkylphenol resins, and halides thereof can also be used.

As the retarder, for example, organic acids such as phthalic anhydride, benzoic acid, salicylic acid, and acetylsalicylic acid; nitroso compounds such as N-nitrosodiphenylamine, N-nitrosophenyl-β-naphthylamine, and polymer of N-nitrosotrimethyldihydroquinoline; halides such as trichloro melanin; 2-mercaptobenzoimidazol; or N-(cyclohexylthio)phtalimide (santo guard PVI) are given.

The content of each of those curing agents is preferably 0.1 to 20 parts by weight, more preferably 1 to 10 parts by weight with respect to 100 parts by weight of thermoplastic elastomer.

The method of producing the composition of the present invention is not limited specifically. For instance, the above-mentioned thermoplastic elastomer, the above-mentioned compound including a metal element, various kinds of additives if required, and so on may be mixed using roller, kneader, extruder, universal stirrer, or the like.

The curing conditions for a permanent crosslinking of the composition of the present invention (by a curing agent) may be favorably selected depending on the various kinds of components or the like to be blended, but are not limited to specific conditions. For example, preferable curing conditions include the conditions under which the curing is performed for 5 to 30 minutes at a temperature of 130 to 200° C.

The composition of the present invention can be softened and imparted with fluidity by heating at about 80 to 180° C. to dissociate the three-dimensional crosslinking bond (crosslinking structure). It is considered that the interaction between the side chains formed between the molecules or formed in the molecule becomes weakened.

For example, the composition of the present invention can utilize the rubber elasticity for various kinds of rubber uses. It is preferable to use the composition as a hot-melt adhesive or an additive to be mixed therewith because the heat-resistance and recycle properties can be increased. It can be used preferably, in particular, for the automobile parts and so on.

More specifically, the automobile parts include, for example, parts of tire such as a tread of a tire, carcass, side wall, inner liner, under tread, and belt portion; exterior parts such as radiator grill, side molding, garnish (pillar, rear, cowl top), aeroparts (air dam, spoiler), wheel cover, weather strip, cowbelt grill, air outlet louver, air scoop, hood bulge, ventilator part, anticorrosion countermeasure parts (overfender, side seal panel), molding (window, hood, door belt), marks; interior window flame parts such as door, light, weather strip of wiper, glassrun, glass-run channel; air duct hose, radiator hose, break hose; lubricant-series parts such as crankshaft seal, valve stem seal, head cover gasket, A/T oil cooler hose, transmission oil seal, P/S hose, P/S oil seal; fuel-series parts such as hose for fuel, emission control hose, inlet filler hose, diaphragms; vibration-proof parts such as engine mount, intank pump mount; boots such as CVJ boot, rack & pinion boot; air conditioning parts such as A/C hose, A/C seal; belt parts such as timing belt, belt for supplementary machine; sealers such as windshield sealer, vinyl plastic sol sealer, anaerobic sealer, body sealer, spot weld sealer; and the like.

When the composition of the present invention is contained as a rubber modifier such as flow preventive, in resins or rubbers causing cold flow at room temperature, flow in extrusion or cold flow can be prevented.

Furthermore, the composition of the present invention can be particularly preferably used in the applications of tires, hoses, belts, seats, vibration-proof rubbers, rollers, linings, rubberized fabrics, sealing members, gloves, fenders, and so on by containing carbon black and/or silica, to thereby provide the product with increased tensile strength, tear strength, flexural strength, and so on.

The thermoplastic elastomer composition of the present invention is produced while setting a compound including a metal element to be added as a compound containing a metal element belonging to Group 1 of the periodic table, so that it can be provided as a composition having an extremely excellent recycle property and an improved compression set.

### EXAMPLE

Hereinafter, the present invention will be more specifically described based on examples. However, the present invention is not limited to the following examples.

A thermoplastic elastomer was prepared through synthesis by the following method.

(Thermoplastic Elastomer 1)

4H-3-amino-1,2,4-triazole (manufactured by Nippon Carbide Industries Co., Inc.) in an amount of 1.88 g (22.4 mmol) was added in 100 g of maleic anhydride modified ethylene-propylene copolymer (manufactured by DSM Co., Ltd., trial product, ethylene content: 60 mol %, maleic anhydride modification ratio: 0.8 mol %, and weight average molecular weight: 90,000) (maleic anhydride skeleton: 22.4 mmol), followed by kneading with a kneader for 30 minutes at 170° C.

The reaction product was subjected to NMR and IR to confirm that it was a thermoplastic elastomer having the following structure (formula (4)).

(Thermoplastic Elastomer 2)

Instead of 4H-3-amino-1,2,4-triazol, 4-aminopyridine was used and the same synthetic process as that of the thermoplastic elastomer 1 was conducted to prepare a thermoplastic elastomer. It was confirmed in a similar method that the resulting elastomer had the following structure (formula (5)).

(Thermoplastic Elastomer 3)

Instead of 4H-3-amino-1,2,4-triazol, 2-aminopyridine was used and the same synthetic process as that of the thermoplastic elastomer 1 was conducted to prepare a thermoplastic elastomer. It was confirmed in a similar method that the resulting elastomer had the following structure (formula (6)).

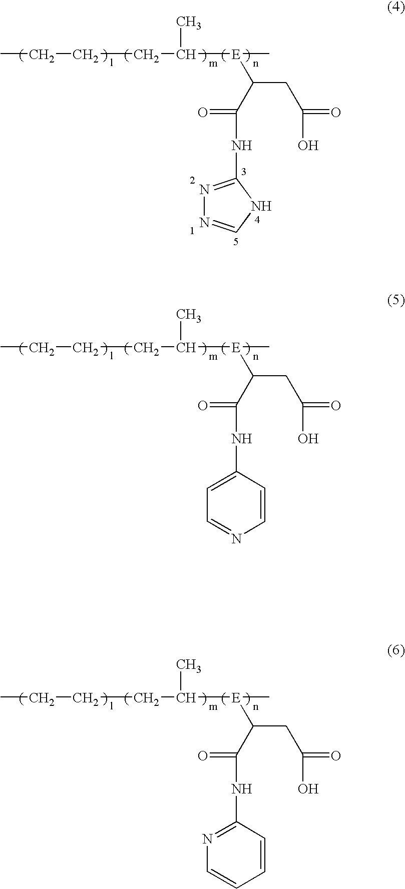

(wherein E represents an ethylene residue or a propylene residue. In addition, 1 represents the content of ethylene, m represents the content of propylene, and n represents a maleic anhydride modification ratio).

The following compounds that contain the respective metal elements were used. In Table 1 and Table 2, it should be noted here that “acac” used in the compound that contains a metal element denotes acetyl acetonate.

That is, there are included: LiBF₄, Li(acac), Co(acac)₂, Mn(acac)₂, Ca(acac)₂, and Mn(acac)₃ (reagent, available from Tokyo Kasei Kogyo Co., Ltd.); K(acac) and Na(acac) (reagent, available from Aldrich Co., Ltd.); and NaOH, Cu(acac)₂, and Ti(O-n-Bu)₄ (reagent, available from Kanto Chemical Co., Inc.).

### Examples 1 to 8 and Comparative Examples 1 to 9

The obtained thermoplastic elastomers 1 to 3 and the compounds containing metal elements (In Table 1 and Table 2, represented as “metal compounds”) were combined as shown in Table 1 and Table 2. An elastomer composition was prepared by mixing (kneading) the nitrogen-containing heterocycle contained in the thermoplastic elastomer with the compound containing the metal element in an addition amount (equivalent) shown in Table 1 and Table 2.

The crosslinking density and the compression set of the respective composition thus obtained were measured to estimate the recycle property of the composition. The results are listed in Table 1 and Table 2.

(Measurement of Crosslinking Density)

Each composition obtained as described above was swelled with toluene, followed by calculating the crosslinking density ν of the composition using the following equation of Flory-Rehner.

ν={ln(1−v)+v+χv²}/2V(v^{1/3}−v²/2)

(wherein v represents the volume fraction of the rubber after swelling, V represents the molecular volume of the solvent (m³/mol), and χ represents a parameter of the interaction between the solvent and the rubber). (Compression Set (C-Set)) For each of the elastomer compositions described above, a plurality of sheets of 2 mm in thickness were formed through hot press for 10 minutes at 170° C. Seven sheets were stacked one after another and subjected to the hot press for 20 minutes at 170° C. to thereby prepared a Lubke sample (i.e., a cylindrical sample of 29 mm in diameter and 12.5 mm in thickness).

The resulting sample was compressed by 25% with a dedicated jig, and was then left to stand for 22 hours at 70° C. Subsequently, the compression set of the sample was measured according to JIS K 6262.

(Recycle Property (Repetitive Molding Examination))

For each of the elastomer compositions, a sheet of 2 mm in thickness was prepared by hot-pressing the composition for 10 minutes at 170° C. Then, the sample in sheet shape was cut into small pieces and was then subjected to press-molding again. The elastomer composition was evaluated in terms of the number of times a seamless sample as an integrated product could be made. Evaluations are based on following.

“∘” means that the seamless samples were prepared repeatedly 10 times or more;

“Δ” means that the seamless samples were prepared repeatedly 5 to 9 times;

“x” means that the seamless samples were prepared repeatedly 2 to 4 times; and

“xx” means that the seamless samples were prepared only once.

TABLE 1

| | Example | | | | | | | |
|---|---|---|---|---|---|---|---|---|
| | 1 | 2 | 3 | 4 | 5 | 6 | 7 | 8 |
| Thermoplastic elastomer | 1 | 1 | 1 | 1 | 1 | 1 | 2 | 3 |
| metal compound | LiBF₄ | Li(acac) | Li(acac) | K(acac) | Na(acac) | NaOH | Li(acac) | Li(acac) |
| (Equivalent) | 1.0 | 1.0 | 0.5 | 1.0 | 1.0 | 1.0 | 1.0 | 1.0 |
| Crosslinking density | 3.29 | 16.60 | 7.00 | 2.43 | 7.42 | 1.96 | 13.60 | 9.60 |
| (mol/m³) | | | | | | | | |
| Compression set (%) | 91 | 81 | 80 | 88 | 86 | 85 | 80 | 80 |
| Recycle property | ∘ | ∘ | ∘ | ∘ | ∘ | ∘ | ∘ | ∘ |

TABLE 2

| | Comparative Example | | | | | | | | |
|---|---|---|---|---|---|---|---|---|---|
| | 1 | 2 | 3 | 4 | 5 | 6 | 7 | 8 | 9 |
| Thermoplastic elastomer | 1 | 1 | 1 | 1 | 1 | 1 | 1 | 2 | 3 |
| metal compound | — | Cu(acac)₂ | Co(acac)₂ | Mn(acac)₂ | Ca(acac)₂ | Mn(acac)₃ | Ti(O-n- | Co(acac)₂ | Co(acac)₂ |
| | | | | | | | Bu)₄ | | |
| (Equivalent) | 0 | 1.0 | 1.0 | 1.0 | 1.0 | 1.0 | 1.0 | 1.0 | 1.0 |
| Crosslinking density | 0.20 | 11.90 | 16.50 | 12.90 | 12.90 | 11.80 | 2.19 | 12.50 | 8.50 |
| (mol/m³) | | | | | | | | | |
| Compression set (%) | 98 | 80 | 78 | 79 | 79 | 78 | 80 | 80 | 79 |
| Recycle property | ∘ | x | Δ | Δ | Δ | Δ | Δ | Δ | Δ |

As is apparent from Table 1 and Table 2, the compositions of the present invention have extremely excellent recycle properties, compared with the compositions (Comparative Examples 2 to 9) including compounds that contain metal elements except those belonging to Group 1 of the periodic table. In addition, each of the compositions of the present invention also has a high crosslinking density and an improved compression set, compared with the composition (Comparative Example 1) without including any compound that contains a metal element.

According to the present invention, therefore, it is possible to provide the thermoplastic elastomer composition having an extremely excellent recycle property and an improved compression set. The composition of the present invention having such features achieves high industrial-applicability and provides great worth to environmental conservation.

What is claimed is:

1. A thermoplastic elastomer composition comprising:
a thermoplastic elastomer having a carbonyl-containing group and a nitrogen-containing heterocycle in a side chain thereof; and
a compound containing a metal element belonging to Group 1 of the periodic table.

2. The thermoplastic elastomer composition according to claim 1, wherein the side chain has a structure represented by the following formula (1): 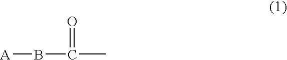
(wherein A represents the nitrogen-containing heterocycle, and B represents: a single bond; an oxygen atom, a nitrogen atom, or a sulfur atom; or an organic group which can include the atoms).

3. The thermoplastic elastomer composition according to claim 1, wherein the side chain has a structure represented by one of the following formulae (2) and (3) and is bonded to a main chain at α-position or β-position: 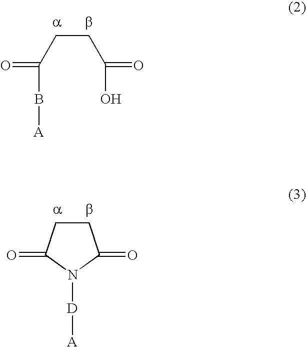
(wherein A represents the nitrogen-containing heterocycle, and B and D independently represent: a single bond; an oxygen atom, a nitrogen atom, or a sulfur atom; or an organic group which can include the atoms).

4. The thermoplastic elastomer composition according to claim 1, wherein
the metal element belonging to Group 1 of the periodic table, which is contained in the compound is selected from the group consisting of Li, Na, and K.

5. The thermoplastic elastomer composition according to claim 2, wherein
the metal element belonging to Group 1 of the periodic table, which is contained in the compound is selected from the group consisting of Li, Na, and K.

6. The thermoplastic elastomer composition according to claim 3, wherein
the metal element belonging to Group 1 of the periodic table, which is contained in the compound is selected from the group consisting of Li, Na, and K.

7. The thermoplastic elastomer composition according to claim 1, wherein
the nitrogen-containing heterocycle is selected from the group consisting of a triazole ring, a thiadiazole ring, a pyridine ring, and imidazole ring.

8. The thermoplastic elastomer composition according to claim 2, wherein
the nitrogen-containing heterocycle is selected from the group consisting of a triazole ring, a thiadiazole ring, a pyridine ring, and imidazole ring.

9. The thermoplastic elastomer composition according to claim 3, wherein
the nitrogen-containing heterocycle is selected from the group consisting of a triazole ring, a thiadiazole ring, a pyridine ring, and imidazole ring.

10. The thermoplastic elastomer composition according to claim 4, wherein
the nitrogen-containing heterocycle is selected from the group consisting of a triazole ring, a thiadiazole ring, a pyridine ring, and imidazole ring.

11. The thermoplastic elastomer composition according to claim 5, wherein
the nitrogen-containing heterocycle is selected from the group consisting of a triazole ring, a thiadiazole ring, a pyridine ring, and imidazole ring.

12. The thermoplastic elastomer composition according to claim 6, wherein
the nitrogen-containing heterocycle is selected from the group consisting of a triazole ring, a thiadiazole ring, a pyridine ring, and imidazole ring.

13. The thermoplastic elastomer composition according to claim 1, further comprising:
at least one of carbon black and silica in 1 to 200 parts by weight with respect to 100 parts by weight of the thermoplastic elastomer.

14. The thermoplastic elastomer composition according to claim 2, further comprising:
at least one of carbon black and silica in 1 to 200 parts by weight with respect to 100 parts by weight of the thermoplastic elastomer.

15. The thermoplastic elastomer composition according to claim 3, further comprising:
at least one of carbon black and silica in 1 to 200 parts by weight with respect to 100 parts by weight of the thermoplastic elastomer.

16. The thermoplastic elastomer composition according to claim 4, further comprising:
at least one of carbon black and silica in 1 to 200 parts by weight with respect to 100 parts by weight of the thermoplastic elastomer.

17. The thermoplastic elastomer composition according to claim 5, further comprising:
at least one of carbon black and silica in 1 to 200 parts by weight with respect to 100 parts by weight of the thermoplastic elastomer.

18. The thermoplastic elastomer composition according to claim 6, further comprising:
at least one of carbon black and silica in 1 to 200 parts by weight with respect to 100 parts by weight of the thermoplastic elastomer.

19. The thermoplastic elastomer composition according to claim 7, further comprising:
at least one of carbon black and silica in 1 to 200 parts by weight with respect to 100 parts by weight of the thermoplastic elastomer.

20. The thermoplastic elastomer composition according to claim 8, further comprising:
at least one of carbon black and silica in 1 to 200 parts by weight with respect to 100 parts by weight of the thermoplastic elastomer.
